(19) United States
(12) Patent Application Publication
(10) Pub. No.: US 2023/0351442 A1
(43) Pub. Date: Nov. 2, 2023

(54) SYSTEM AND METHOD FOR DETERMINING A TARGETED CREATIVE FROM MULTI-DIMENSIONAL TESTING

(71) Applicant: Origin Media Inc., Reno, NV (US)

(72) Inventor: Yiftah FRECHTER, Irvington, NY (US)

(73) Assignee: Origin Media Inc., Reno, NV (US)

(21) Appl. No.: 17/815,357

(22) Filed: Jul. 27, 2022

Related U.S. Application Data
(63) Continuation-in-part of application No. 17/661,478, filed on Apr. 29, 2022.

(51) Int. Cl. G06Q 30/02

(52) U.S. Cl. CPC G06Q 30/0251; G06Q 30/0276; G06Q 30/0242

(57) ABSTRACT

A system and method for determining a targeted creative from multi-dimensional testing includes creating at least one version of a targeted creative, wherein each version of the at least one version includes a creative and a respective topper of a plurality of toppers, wherein the topper is a multimedia content element that is different for each version, wherein creating the at least one version further comprises stitching the creative and the topper based on at least one media parameter of the creative; designating a first version of the targeted creative to a group that includes a plurality of user devices based on a plurality of selecting rules; causing a display of the first version via the plurality of user devices of the group; collecting performance data of the displayed first version from the group; and determining the first version as an optimal version based on the collected performance data.

### CROSS-REFERENCE TO RELATED APPLICATIONS

This application is a continuation-in-part of U.S. application Ser. No. 17/661,478 filed on Apr. 29, 2022, now pending, the contents of which are hereby incorporated by reference.

### TECHNICAL FIELD

The present disclosure generally relates to digital multimedia contents, more specifically to generating and determining of targeted creatives through multi-dimensional testing.

### BACKGROUND

With the prevalence of internet-equipped devices and frequent use in current environments, the market and technology for digital advertisements (ads) are rapidly growing. Traditional advertising methods such as billboards, newspapers, flyers, and the like, are restricted to physical spaces. However, digital advertising that presents advertisements (ads) through various internet-equipped devices such as, but not limited to, computers, mobile devices, smart devices, connected televisions (TVs), smart home devices, and more, eliminates such restrictions of space and time. To this end, digital ads can reach a wide range of audiences that were not available through traditional methods.

Television (TV) ads are traditionally one of the major methods of advertising to reach many households. However, TV ads can be expensive yet ineffective since it is prepaid prior to airing of the show and/or ad and provided for a wide range of audiences without much tailoring to a specific group of audiences. And thus, methods to combine the effectiveness of TV ads in the growing of digital advertising markets are being explored.

Particularly, over the top (OTT) creatives (or ads) provided through media streaming platforms can reach a wide range of audiences through various internet-equipped devices. Unlike traditional TV ads, such OTT creatives may be purchased in or near real-time when the audiences access the OTT content through the media streaming platform. In this scenario, the OTT creatives may choose to be presented to select audiences and not to others. As an example, a creative related to a toy may be presented to one viewer and not the other, even though both viewers are streaming an animated family movie, based on information of each viewer.

Current solutions of purchasing ad slots for the display of creatives rely on limited available data. The decision is often based on user and/or device data such as, but not limited to, demographics, locations, interests, and the like, that are provided by the ad server. Although some selectivity and targeting of viewers are enabled by purchasing of ad slots based on user and/or device data, it has been identified that such selection does not directly translate into increased engagement or performance of the creatives. That is, the selectively purchased and displayed creatives may still be overlooked by the viewers by, for example, walking away, not remembering, performing another activity, and the like, and any combination thereof. Thus, methods to improve viewer engagement and the performance of displayed creatives are desired.

More accurate matching of user data and creatives may be a solution to improve creative performances. However, given the extensive increase of OTT platforms, content, devices, and users, accurate customization for each creative being served is implausible and impractical. It should also be noted that operations in digital advertisement are typically completed in less than few seconds. And thus, effectively and rapidly serving relatable creatives still remain a challenge.

In addition, it has been identified that gauging the performance and engagement of projected creatives are a challenge in OTT advertising. Web pages provide a wide range of user-related and impression data when the creatives are presented. These data are then utilized to determine effectiveness and improve targeting of creatives. However, such depth of data is still missing in OTT advertising systems, preventing efficient customization of creatives and feedback data on the projected creatives. And thus, methods to collect performance and engagement analysis and, effectively implement such data for customized and personalized targeting in OTT advertising is desired.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining a targeted creative from multi-dimensional testing. The method comprises: creating at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative; designating a first version of the at least one version of the targeted creative to a group based on a plurality of selecting rules, wherein the group includes a plurality of user devices; causing a display of the first version via the plurality of user devices of the group; collecting performance data of the displayed first version from the group; and determining the first version as an optimal version of the targeted creative based on the collected performance data.

Certain embodiments disclosed herein also include a non-transitory computer readable medium having stored thereon causing a processing circuitry to execute a process, the process comprising: creating at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative; designating a first version of the at least one version of the targeted creative to a group based on a plurality of selecting rules, wherein the group includes a plurality of user devices; causing a display of the first version via the plurality of user devices of the group; collecting performance data of the displayed first version from the group; and determining the first version as an optimal version of the targeted creative based on the collected performance data.

Certain embodiments disclosed herein also include a system for determining targeted creatives from multi-dimensional testing. The system comprises: a processing circuitry; and a memory, the memory containing instructions that, when executed by the processing circuitry, configure the system to: create at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative; designate a first version of the at least one version of the targeted creative to a group based on a plurality of selecting rules, wherein the group includes a plurality of user devices; cause a display of the first version via the plurality of user devices of the group; collect performance data of the displayed first version from the group; and determine the first version as an optimal version of the targeted creative based on the collected performance data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram illustrating the generation of targeted creatives according to an embodiment.

FIG. 3 is a flowchart illustrating a method for serving a targeted creative according to an embodiment.

FIG. 4 is a flowchart illustrating a method for generating a targeted creative according to an embodiment.

FIG. 5 is a flowchart illustrating a method for performing a multi-dimensional testing of a version of a targeted creative according to an embodiment.

FIG. 6 is a schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method for determining a targeted creative from multi-dimensional testing to generate and provide customized targeted creatives of improved multimedia content quality that enhances performance of creatives in digital advertising. A targeted creative includes a multimedia element, topper, and bidding creative that are accurately matched and connected. The topper and the bidding creative are stitched together to create a single non-disruptive, seamless creative. Such targeted creatives are customized for the user and/or group of users based on data provided by the advertisement (ad) server and/or publisher, such as a media streaming platform. It should be noted that the targeted creative provides improved creatives (i.e., media) both in the content and playback (i.e., how it plays) in presenting to a viewer, in return improving user engagement and performance of the bidding creative.

According to the disclosed embodiments, the bidding creatives and the toppers that make up the targeted creatives are accurately matched based on the context on the bidding creative and toppers. In further embodiment, user and/or device data may also be used for matching. To this end, by incorporating another multimedia element, of the topper, additional targeting and customization for the viewer may be established. In such a scenario, the targeting of individual or group of viewers may be efficiently performed without extensive processing to find relevant matches in vast amounts of data.

According to the disclosed embodiments, a multi-dimensional testing of targeted creatives and/or specifically one or more versions of a particular creative enables objective selection of a version of the particular creative based on performance data. Rather than a subjective determination of an effective version of the targeted creative based on feeling, the selection is performed on objective analysis performance data. Moreover, multi-dimensional testing for determining the targeted creatives enables analysis while considering various, multiple aspects and factors of the targeted creatives such as, but is not limited to, creative types, creative categories, topper type, topper category, order of stitching, and the like, and any combination thereof. To this end, a multi-dimensional testing of targeted creatives allows a more accurate and granular analysis and determination of targeted creatives, which in return improves performance and engagement of seamless targeted creatives that are created. It should be further appreciated that multi-dimensional testing utilizes near real-time performance feedback from displaying the targeted creatives to user devices, which are continually and rapidly processed and implemented.

In addition, the disclosed embodiments are connected to a real-time bidding system in digital advertising and thus, perform rapid matching and generating of targeted creatives in near real-time. It should be appreciated that uninterrupted analyses and generation of new targeted creatives (i.e., new seamless multimedia content) enable effective and efficient creative serving. Moreover, continuous generating, serving, and multi-dimensional testing of multiple targeted creatives as well as at least one version of each targeted creative are performed at a sufficient fast rate. And thus, operations according to the embodiments herein cannot be performed manually.

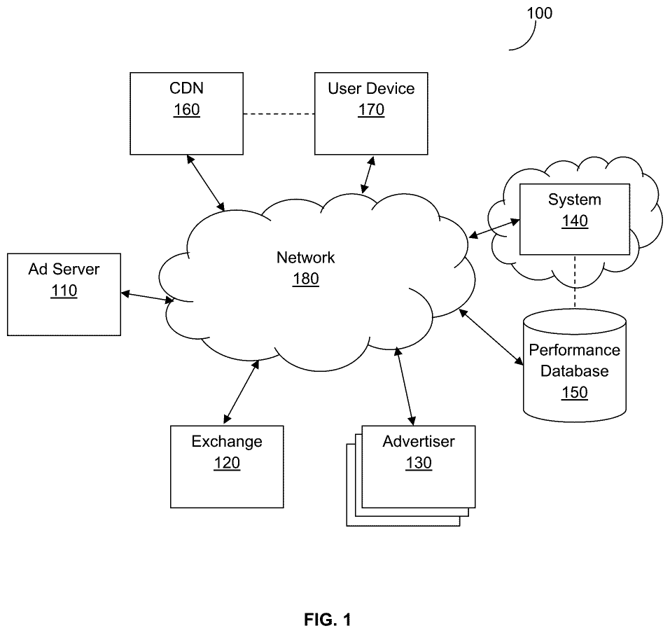

FIG. 1 shows an example network diagram 100 utilized to describe the various disclosed embodiments. In the example network diagram 100, an ad server 110, an exchange platform 120, an advertiser 130, a system 140, a performance database 150, a content delivery network (CDN) 160, and a user device 170 connected to a network 180. The network 180 may be, but is not limited to, a wireless, a cellular or wired network, a local area network (LAN), a wide area network (WAN), a metro area network (MAN), the Internet, the worldwide web (WWW), similar networks, and any combination thereof.

The network 180 may be configured to connect to the various components of the system via wireless means such as Bluetooth (tm), long-term evolution (LTE), Wi-Fi, other, like, wireless means, and any combination thereof, via wired means such as, as examples and without limitation, Ethernet, universal serial bus (USB), other, like, wired means, and any combination thereof. Further, the network 180 may be configured to connect with the various components of the system via any combination of wired and wireless means.

The ad server 110 is configured to provide creatives (or ads) to audiences of the content streamed from media streaming platforms. In some configurations, the ad server 110 is configured to serve creatives to various publishers (e.g., media streaming platforms) which are suppliers of, for example, but not limited to, TV show, movies, streaming media, live streaming, and the like, via a user device 170, such as but not limited to, a personal computer, a tablet, a connected television (CTV), and the like, and any combination thereof. In some configurations, the ad server 110 may act as an aggregator to provide list of available content of various publishers to control portions of the ad slot inventory. The ad server 110 may be implemented as a physical device, a system, component, or the like, as a virtual device, system, component, or the like, or in a hybrid physical-virtual implementation.

The ad server 110 generates an ad request, a data feature, based on user access to media content, for example, a video clip, including ad slots. The data features of the ad request may include data points or descriptors such as, but not limited to, demographics, internet protocol (IP) addresses, (or location descriptor), interest, and the like, or any combination thereof of a user and/or a device from which the access was made. The data features may further include metadata such as, but not limited to, content player parameters, duration of ad slot, time stamp, bandwidth, and the like. The generated ad request is supplied to the exchange platform 120 for advertisers 130 to bid on the ad request for projecting during the associated ad slot. The ad server 110 receives bids, together with the uniform resource locator (URL) of the creative for the bid, in response to the ad request from the exchange platform 120 to decide on the winning bid of a specific creative. The creative (ad) with the winning bid is served to the CDN 160 for presenting to a user through a user device 170. The ad request may be obtained from the user device 170 and/or through the CDN 160.

The creative served to the CDN 160 are typically processed and presented over a web browser, a mobile application (app), or a CTV. The creative may include, but not limited to, a multimedia content element such as an image, text, video, and the like, or any combination thereof. The transaction between the ad server 110 and the exchange platform 120 may be sufficiently rapid to provide real-time or near real-time bidding on the ad slot based on the transmitted ad request.

The ad server 110 may further be connected to the system 140 and the performance database 150, over the network 180. According to the disclosed embodiments, the ad server 110 may collect performance metrics such as, but not limited to, impressions, clicks, view length, QR code reading, and the like, and any combination thereof, and provide to the system 140 and/or the performance database 150. In further embodiment, a performance report of the collected performance metric may be generated and supplied to the system 140.

The exchange platform 120 is a system, component, device, or the like, configured as an open market to facilitate transactions between advertisers and publishers in serving creatives to content users. The exchange platform 120 may be configured to receive ad requests from the ad server 110. Such requests are data features including, but not limited to, device ID, user ID, app ID, and the like, and any combination thereof, and include related user and/or device information such as location, demographics, interests, and more. As an example, an ad request for an ad slot in a family animation movie may include data points providing information such as the app from which the content is accessed, the user location, the time at which content and/or ad slot is accessed, the family structure, and the like.

The ad request may be transmitted to the advertiser 130 and/or system 140 for bidding of the ad slot to project a specific creative. It should be noted that although the advertiser 130 and the system 140 may both bid on the ad slot in response to the ad request, the decision to bid on the ad request is primarily performed at the advertiser 130. The exchange platform 120 may be a physical system, a component, device, or the like, a virtual system, component, device, or the like, or any combination thereof.

In an embodiment, the exchange platform 120 may include: a demand-side platform (DSP), a supply-side platform (SSP), or a data management platform (DMP). Moreover, in some embodiments, the exchange platform 120 may include a real-time bidding (RTB) system configured to enable real-time bidding of ad requests. According to the disclosed embodiments, the exchange platform 120 provides a list of live creatives, that is, creatives that are actively bidding on the ad slot of the ad request, to the system 140.

The advertiser 130 is a system, a device, a component, or the like, or any combination thereof, configured to provide bids in response to ad request calls from the exchange platform 120. The advertiser 130 makes the decision to bid on the ad request, at varied amounts, based on a predetermined campaign, which is sent to the exchange platform 120.

The system 140 is a device, component, system, or the like, configured to serve targeted creatives for content audiences in real-time or near real-time. According to the disclosed embodiments, the system 140 receives a plurality of live creatives from the exchange platform 120 which are creatives that are actively bidding on the ad slot in response to the ad request call from the ad server 110. The system 140 is configured to read portions of the live bidding creatives to identify and/or generate a targeted creative for at least one of the read live bidding creatives. In an embodiment, a targeted creative includes a creative (e.g., the bidding creative) and a topper, a multimedia content element which are smoothly stitched together into a single creative. A multimedia content element may include such as, but not limited to, an image, text, survey, video, and the like, and any combination thereof. As an example, the topper may be a 12-second video including texts and various images. In an embodiment, the system 140 may simultaneously read a plurality of bidding creatives that is received. In an embodiment, the system 140 may be configured to read creatives with priorities on bidding creatives with high throughput.

The targeted creative may be identified based on analysis of performance data such as, but not limited to, performance metrics, survey metrics, and the like, that are retrieved from the performance database 150, of each of the targeted creatives. Additionally, data features of the ad request and publisher data from the ad request may be utilized for identifying the targeted creative. The publisher data may include, for example, but is not limited to, content genre, content category, and the like, and any combination thereof, which may be utilized for identifying targeted creatives or toppers to create such targeted creatives.

In another embodiment, the plurality of live creatives may include creatives that are predetermined and known to the system 140. In some embodiments, the system 140 may be configured with a list of known creatives to efficiently read the known creative and identify one or more associated targeted creatives.

In an embodiment, the system 140 may place a bid at the exchange platform 120, by utilizing the identified and/or generated targeted creative. In a further embodiment, the targeted creative may be swapped in place of the respective bidding creative (which is already included in the generated targeted creative) for bidding on the same ad request. Upon determination as the winning bid of the particular ad request, the ad server 110 may be supplied with the winning targeted creative (e.g., the URL of targeted creative). In an embodiment, the system 140 may choose to bid using the original creative (i.e., creative without a topper) that the advertiser provided without replacing with the targeted creative. In another embodiment, the system 140 may determine not to bid on the ad request.

According to the disclosed embodiments, the system 140 includes a matching engine (not shown) to determine a match between at least one creative (e.g., incoming bidding creative, known creative, and more) and at least one topper. The matching engine may apply at least one algorithm, such as a machine learning algorithm, on the creative and a plurality of toppers in the system 140. One or more toppers may be stored in a memory, such as within the system 140, and retrieved to be used in the matching engine. In an embodiment, the matching of the at least one creative and the at least one topper may be based on historical data such as, but not limited to, performance data, previously presented targeted creatives, and the like, and any combination thereof. In a further embodiment, the matching may be also based on data from the publisher. Such data may include publisher traffic data, content genre, as well as data and metadata of the ad request. The matching engine is configured to determine media parameters such as, but not limited to, resolution, bitrate, frame rate, aspect ratio, and the like, of the matched creative and topper for generating the targeted creative.

In an embodiment, a creative is matched with one or more toppers to create one or more versions of a targeted creative for the respective creative. In such case, each version of the targeted creative includes a different topper from a plurality of matched (i.e., potential) toppers, but identical respective creative. In another embodiment, the respective creative may not be identical but closely related creatives that the advertiser 130 selected for the same campaign. In an embodiment, the one or more versions of the targeted creative that are created is stored in, for example, a performance database 150.

According to the disclosed embodiments, the system 140 further includes one or more stitching workers (not shown) configured to combine matched creative and topper sets and create targeted creatives. Such targeted creatives are created near real-time and utilized for bidding on the ad request. A stitching worker is configured to receive the matched creative and topper set, as well as associated parameters in order to create a non-disruptive single targeted creative. In an embodiment, the topper may be a multimedia content of, for example but not limited to, 5-15 seconds, which may be stitched before or after the respective creative.

In a further embodiment, the system 140 may include a decision engine (not shown) that is configured to analyze targeted creative and/or topper efficiency in real-time, based on performance metrics received in response to projecting via the user device 170. Such decision engine may be utilized for multi-dimensional testing that is further discussed below. It should be noted that the stitching worker and the decision engine may be realized using hardware processor.

As an example, the stitching worker receives a 10-second topper at a frame rate of 30 frame per second (fps) and a 30-second creative at a frame rate of 25 fps from the matching engine. The stitching worker is configured to modify the topper frame rate to generate a 40-second targeted creative with a frame rate of 25 fps for bidding and, if won, projecting at the user device 170. In an embodiment, the targeted creatives generated through stitching is stored in a memory. In another embodiment, the generated targeted creatives is stored in the performance database 150.

According to the disclosed embodiments, the system 140 is configured to perform a multi-dimensional testing of targeted creatives based on performance metrics. The multi-dimensional testing enables identifying and/or eliminating targeted creatives, as well as different versions of a specific targeted creatives. In addition, testing allows further analysis and implementation of performances for creating targeted creatives. In an embodiment, testing is based on the near real-time performance metrics received at the system 140. In further embodiment, the decision engine of the system 140 may be utilized to determine effectiveness based on performance data. It should be appreciated that multi-dimensional testing enables rapid processing of a plurality of targeted creatives or versions of a targeted creative. Moreover, continuous multi-dimensional testing provides granular performance analyses with respect to, for example but not limited to, topper type, category of creative, user device 170, and the like, and any combination thereof.

In an embodiment, the multi-dimensional testing is utilized to determine specific versions of a targeted creative based on performance data, which may be selected for bidding on ad slots over other versions of the targeted creative. As noted above, each version of a targeted creative includes at least one topper that is distinct from another version and the respective topper that are matched by the matching engine. In another embodiment, one or more versions of the targeted creative may include few, for example but not limited to, one to three options of the respective creative in a campaign.

For a single digital ad campaign associated to a specific creative, the system 140 is configured to create one or more test groups with each test group including a plurality of user devices 170. In an embodiment, the test group and its plurality of user devices 170 remain consistent within the single ad campaign to receive a uniquely designated version(s) of the targeted creative. In an example embodiment, a control version of the targeted creative including only the respective creative without the topper (i.e., the original creative) is created and designated to one of the test groups. It should be noted that more than one multi-dimensional testing are simultaneously performed for the multiple bidding creatives that are received at the system 140.

The performance database 150 is configured to store performance data of projected creatives and toppers. The performance data may include engagement metrics such as, but not limited to, skips, time duration of view, completion rate, clicks, and the like, as well as survey metrics such as, memorability score, engagement score, entertainment score, and the like, obtained from a predetermined group of audiences. In an embodiment, the survey metric may be provided from third-party companies as raw data and/or analyzed data with respect to various features, for example, demographics, location, viewed content, creatives presented, and the like. In a further embodiment, the performance database 150 is configured to store the targeted creatives (and at least one version of each of the targeted creatives) generated and/or presented to a viewer of a user device 170. The performance database 150 may also store portions of user device information such as, but not limited to, device ID, user ID, and the like. In an embodiment, personal information about the user devices 170 is not stored in the performance database 150. In an embodiment, the survey metrics provide additional performance information that may not be accurately portrayed by the engagement metrics. For example, the survey metric can be an indication whether a user actually saw the targeted creative, and not walk away while the targeted creative was being displayed on the user device, which will still show as complete playback of targeted creative regardless of the user actually watching the targeted creative.

The content delivery network (CDN) 160 is a system, component, device, or the like, or any combination thereof, configured to provide targeted creatives to a user device 170 to be presented to the viewers. According to the disclosed embodiment, the CDN may receive a targeted creative of the winning bid from the ad server 110. In an embodiment, the targeted creative may be supplied to a CDN 160 located closer to the specific user device 170 from which the access was requested to the ad server. In some configurations, the CDN 160 may be configured to use an ad insertion service to provide the target creatives to a user though a media streaming platform.

The user device 170 is, but not limited to, a personal computer, a laptop, a tablet computer, a smartphone, a connect television (CTV), or any other device capable of receiving and displaying content, including, but not limited to, targeted creatives. In an embodiment, the user device 170 may access media streaming platforms over the network, such as the Internet, for requesting and receiving media content. The user device 170 may be connected with the ad server 110 and the CDN 160 over the network 180. In some configurations, the user device 170 may be directly connected to the CDN 160 to rapidly receive media content and various creatives upon generation of an ad request.

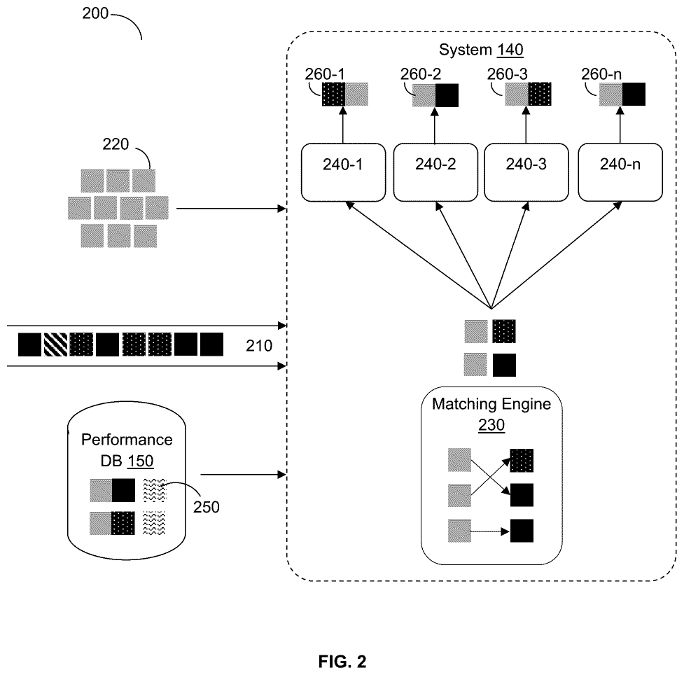

FIG. 2 is an example schematic diagram 200 illustrating the generation of targeted creatives according to an embodiment. The flow diagram 200 herein may be performed within the system 140, FIG. 1. For simplicity and without limitation of the disclosed embodiments, FIG. 2 will also be discussed with reference to the elements shown in FIG.

The flow diagram 200 illustrates operations of generating targeted creatives by utilizing components of the system 140. The system 140 is configured to receive input data including, but not limited to, a plurality of live bidding creatives 210, a plurality of toppers 220, performance data 250, and any combination thereof. The input data may be utilized to create targeted creatives 260-1 through 260-n (hereinafter referred to individually as a targeted creative 260 and collectively as targeted creatives 260, merely for simplicity purposes) that are customized for a certain ad request, and in return a certain user device 170. Such created targeted creative 260 is a single creative that includes at least one topper 220 and a bidding creative 210 seamlessly stitched together. It should be noted that the generation of targeted creatives can be performed in near real-time within, for example, tens of seconds to be implemented in the digital advertising ecosystem as described herein above.

According to the disclosed embodiments, the system 140 is configured to receive a stream of bidding creatives 210 from an exchange platform 120. The stream of bidding creatives includes a plurality of different creatives (or ads) 210 that bid on a specific ad request. In an embodiment, the system 140 may also receive data descriptors such as, but not limited to, demographics, location descriptors, interests, and the like, and any combination thereof, of the user and/or user device 170 of the specific ad request. In a further embodiment, the system 140 may receive publisher data such as, but not limited to, content category, genre, rating, and the like, and any combination thereof.

The system 140 may read and/or extract data from each of the plurality of creatives received through the stream to determine contexts for each of the plurality of creatives and for matching with at least one topper. In an embodiment, the system 140 may prioritize reading and/or extracting data from certain creatives with an activity value greater than a predetermined threshold value over other creatives that show lower activity values. That is, creatives that show a sufficient number of bids for ad slots may be read first for replacing with a targeted creative. In such cases, some incoming creatives may not be read due to low activity values below the predetermined threshold value. In another embodiment, the system 140 may prioritize reading and/or extracting data from certain creatives based on a predetermined priority list. In an embodiment, the stream of bidding creatives 210 may also include creatives that are directly from the advertiser 130.

In an embodiment, the system 140 is configured to classify the bidding creative to categories, for example but not limited to, arts, automotive, business, education, and more, based on the content (or context) of the creative. In another embodiment, the creatives is classified into categories based on a predefined list of advertisers for each of the categories. In yet another embodiment, the read creatives is provided to training personnel.

In an embodiment, a plurality of toppers 220 may be selected based on the creatives retrieved from the memory of the system 140. The plurality of topper 220 may be classified into categories, similar to that of the creatives, for example, in a predetermined list. In a further embodiment, performance data 250 such as, but not limited to, the performance metric and the survey metric, associated with the read creative and/or the selected toppers may be retrieved from the performance database 150. The performance data 250 may be historical and/or near real-time performance data collected as feedback from projecting targeted creatives through a user device 170. The performance metric may include, but not limited to, clicks, QR code access, impressions, view length, and the like, and any combination thereof, which may be collected from the ad server 110. The survey metric that includes, for example, memorability score, engagement score, entertainment score, positivity score, and the like, may be collected from a predetermined group of audiences to indicate effectiveness of the projected creatives. In an embodiment, the survey metric may be provided by third-party companies in predefined time intervals.

According to the disclosed embodiments, the matching engine 230 may apply at least one algorithm, such as a machine learning algorithm, on the creatives 210, toppers 220, and the performance data 250 to determine at least one match for a portion of the plurality of creatives 210. In further embodiment, the matching engine 230 extracts media parameters such as, but not limited to, resolution, bitrate, frame rate, aspect ratio, and the like, of the creative 210 and the topper 220 in the at least one match.

In an embodiment, the set of creative and topper match, as well as the extracted media parameters, may be provided to a stitching worker (e.g., the stitching workers 240-1 through 240-n, hereinafter referred to individually as stitching worker 240 and collectively as stitching workers 240, merely for simplicity purposes) to generate a smoothly combined targeted creative (e.g., 260-1 through 260-n). In an embodiment, the topper is stitched before the beginning of the matched creative (e.g., for the topper to play before the creative). In another embodiment, the topper is stitched after the termination of the matched creative (e.g., for the topper to play after the creative).

The stitching worker 240 is configured to align (or synchronize) the media parameters of the matched creative and topper in order to generate a single targeted creative that can consecutively present the topper and the creative one after the other in a non-disruptive manner. In an embodiment, the media parameters of the toppers may be modified to synchronize to the media parameters of the creatives. The system 140 includes a plurality of stitching workers 240 to independently and simultaneously generate a plurality of targeted creatives based on the matches provided by the matching engine. In an embodiment, a plurality of versions of a targeted creative is generated to include different versions, each including a different topper, synchronized to the unique creative. In an embodiment, the generated targeted creatives may be utilized for bidding of the specific ad request for which the bidding creatives 210 were bid for. It should be noted that the generation of targeted creatives described herein are performed in near real-time.

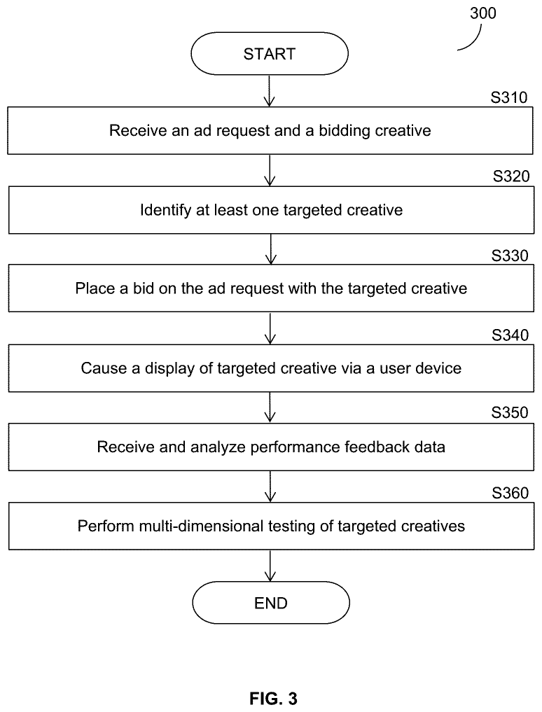

FIG. 3 is an example flowchart 300 illustrating a method for serving a targeted creative according to an embodiment. The method described herein may be executed by the system 140, FIG. 1. It should be noted that the method described herein is performed within tens of seconds during the rapid transactions occurring in the advertising ecosystem described hereinabove.

At S310, an ad request and a bidding creative are received. The ad request generated from an ad server (e.g., the ad server 110, FIG. 1) is received together with a plurality of bidding creatives that bid on an ad slot associated with the ad request. The ad request includes data features such as, but not limited to, demographics, IP address, interest, family structure, and the like, that provide information about the user and/or device in which the ad request was generated for. In an embodiment, at least one of the plurality of creatives may be selected. As noted above, the at least one of the plurality of creatives may be selected based on priority, which may depend on, for example, but not limited to, a predetermined priority list of creatives, activity level of creative, high throughput on bidding, and the like. In further embodiment, the at least one of the plurality of creatives may be selected from a predetermined list of known creatives within the memory.

At S320, at least one targeted creative is selected based on the bidding creative. The at least one targeted creative that contains the bidding creative is selected from a plurality of targeted creatives. In an embodiment, the plurality of targeted creatives may be stored in a memory or a performance database (e.g., the performance database 150, FIG. 1). In an embodiment, the targeted creative may be determined based on analysis of data features of the ad request, the bidding creative, historical performance data of the targeted creatives, toppers of the targeted creatives, publisher data, and the like. In a further embodiment, the bidding creative may be classified into certain categories, which may be utilized for determining the at least one targeted creative.

As an example, two targeted creatives including the same bidding creative but each with distinct toppers may be available. In the same example, the performance data may indicate that the first targeted creative resulted in greater completion rate for users who are men in the age group of 40s compared to the second targeted creative. In the case where the user is identified as a man in their 40s, the first targeted creative can be selected as at least one targeted creative. It should be noted that the topper in the selected targeted creative provide a more accurate and personalized targeting of the bid creative for the viewer of the associated ad request and streamed content.

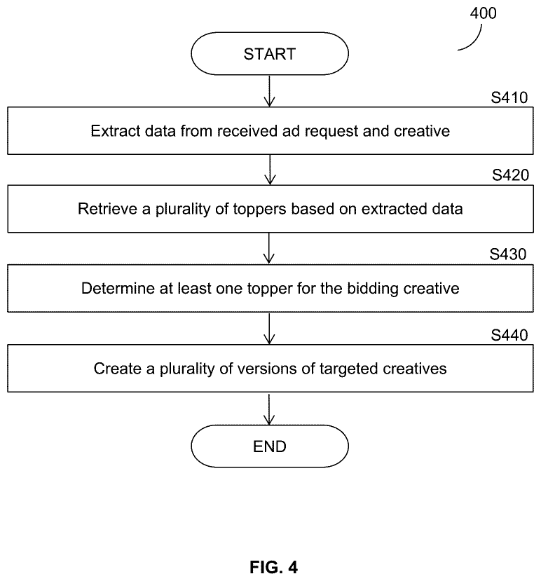

In an embodiment, the at least one targeted creative may not be available from the stored plurality of targeted creatives. In such case, at least one targeted creative may be generated as described herein below in FIG. 4. In another embodiment, the targeted creative may not be selected, and thus, the original bidding creative (or control version of the creative) without a topper may be used for the following steps.

At S330, a bid is placed on the ad request with the identified targeted creative. The bidding creative received (in S310) may be replaced with the at least one identified targeted creative, including the received bidding creative and a topper. In an embodiment, a price for bidding may be stored in the memory and/or performance database (e.g., the performance database 150, FIG. 1). In an embodiment, a URL for the identified targeted creative may be sent to replace the URL of the received bidding creative.

At S340, upon a determination as a winning bid, the targeted creative is caused to display to a viewer via a user device. The targeted creative selected based on user data, performance data, and the like, provides a personalized creative based on the ad request. In an embodiment, the targeted creative may be provided to the ad server (e.g., the ad server 110, FIG. 1) that determines the winning bid for the ad request. It should be appreciated that the personalized targeted creative is not only more accurate in targeting but is presented in a non-disruptive manner to improve the viewer experience.

At S350, performance feedback data is received. The performance feedback data includes, but not limited to, performance metrics and the survey metrics. The performance metrics may be received immediately upon projecting the targeted creatives from, for example, the ad server and/or media streaming platform. The survey metrics, for example but not limited to, memorability score, engagement score, entertainment score, and the like, may be obtained from a predetermined group of viewers. The survey metrics indicate a degree of engagement and effectiveness of the projected targeted creatives that are difficult to obtain in media streaming advertising. In an embodiment, the survey metrics may be received as raw data and/or analyzed reports at a predefined time interval or after a predetermined duration of time. The survey metrics may be stored together with the targeted creatives and the performance metrics in the performance database (e.g., the performance database 150, FIG. 1). In further embodiment, the survey feedback may be provided by third party companies.

The performance feedback data may be analyzed to determine scores for various performance metrics and survey metrics. In an embodiment, such scores may be stored and utilized as historical performance data of respective target creatives or original creatives for future reference. In an embodiment, implementing the performance feedback data may be immediately performed to more accurately identify and/or generate targeted creatives within a sufficiently short amount of time. In an embodiment, performance feedback data may be collected and analyzed to perform NB 'testing of the targeted creatives.

In one embodiment, performance feedback data may be iteratively collected for a set of targeted creatives. The set of targeted creatives may include one or more targeted creatives that share a common bidding creative or a common topper. As an example, a set of targeted creatives may include five different versions of targeted creatives all including the same creative from an automotive company. In another example, the set of targeted creatives may include ten different targeted creatives that all include topper C, for example, a media content that displays breaking news. In an embodiment, the different targeted creatives in the set of targeted creatives may be iteratively used for replacing the original bidding creative, when the specific original creative bids on an ad request. In the same scenario, performance data, including the performance metric of each iteration, may be collected and utilized in order to effectively and accurately identify and/or generate at least one version of the targeted creative for the specific common creative. In one example embodiment, the performance data is collected and analyzed separately for the different versions of the targeted creative. In an embodiment, a potential list for a bidding creative may be generated based on a set of targeted creatives that includes a plurality of targeted creatives that each collected performance data equal or greater than a predetermined threshold value. In further embodiment, a targeted creative with a performance data below the predetermined threshold value may be removed from the potential list of for the bidding creative.

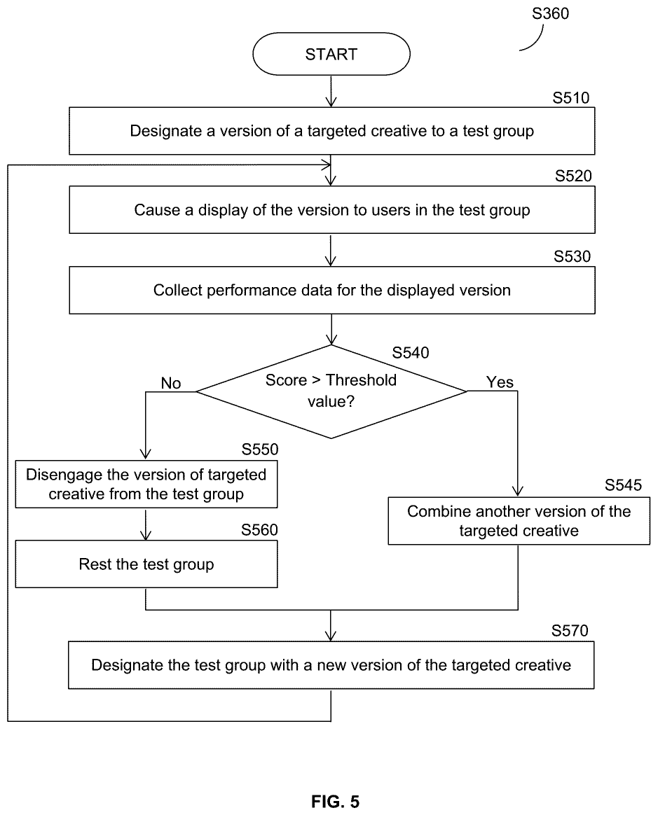

S360, multi-dimensional testing of targeted creatives is performed. The targeted creatives are served to users via user devices (e.g., the user device 170, FIG. 1) as described above in S310 to S340. In an embodiment, performance data may be collected in near real-time in order to gauge effectiveness of the targeted creatives. The details on the method of multi-dimensional testing are further described herein below in FIG. 5. It should be appreciated that multi-dimensional testing enables testing of created targeted creatives, as well as at least one version of a targeted creative, with respect to, for example but not limited to, toppers, category of bidding creative, user device information, and the like, and any combination thereof.

FIG. 4 is an example flowchart 400 illustrating a method for generating a targeted creative according to an embodiment. The method described herein may be executed by the system 140, FIG. 1. It should be noted that the method described herein may be simultaneously and continuously performed to generate one or more targeted creatives at the same time.

At S410, data from an ad request and a bidding creative are extracted. The ad request generated from, for example the ad server (e.g., the ad server 110, FIG. 1), includes data points relevant to the user and/or the device in which the ad request was generated for. Data point such as, but not limited to, demographics, location, hobbies, and the like, may be extract from the ad request for targeted generation and delivery of creatives. In further embodiment, the data point may include metadata indicating, for example, content player media parameters, duration of ad slot, time stamp, and the like, and any combination thereof. In further embodiment, publisher data from a media streaming platform, in which the user is accessing, may also be extracted. The publisher data may include, for example, but not limited to, content genre, streaming traffic data, and the like, associated and provided with the ad request. The bidding creative is received from the stream of the plurality of bidding creatives that bid on the specific ad request. In an embodiment, the bidding creative data provides information about the creative including context, media parameters, length, and the like.

At S420, a plurality of toppers based on extracted data are retrieved. The plurality of toppers that are relevant to the bidding creative may be selected from a larger pool of toppers. In an embodiment, the plurality of toppers may be determined based on the bidding creative data such as, but not limited to, creative context, category, and the like, and any combination thereof. In further embodiment, data from the ad request, including publisher data related to, for example, the content in which the viewer is watching, may be utilized. In yet another embodiment, toppers may be selected based the performance data of targeted creatives, for example. The plurality of toppers may be received from a memory and/or the performance database (e.g., the performance database 150, FIG. 1).

At S430, at least one topper for the bidding creative is determined. A match between the bidding creative and at least one topper is determined based on analysis. In an embodiment, at least one algorithm, such as a machine learning algorithm, may be applied to the creative bidding data, topper data, historical performance data, and the ad request data to determine the match. The bidding creative may be matched to one or more toppers from the plurality of toppers. In an embodiment, the at least one topper for the bidding creative may be determined based on a rule with different weights on the various data noted above. In an example embodiment, a topper may be selected with more weight on the ad request data than the bidding creative data. In an embodiment, media parameters such as, but not limited to, resolution, frame rate, aspect ratio, and the like, may be extracted of the matched bidding creative and topper.

At S440, a targeted creative is created. The targeted creative is a single creative consecutively including, the matched bidding creative and the topper. In an embodiment, the matched bidding creative and the topper are seamlessly stitched together by one of the plurality of stitching workers in the system (e.g., the system 140, FIG. 1). In an embodiment, the stitching workers are provided with the media parameters, which modifies at least one of the bidding creatives and the topper to synchronize and create a non-disruptive targeted creative. In an embodiment, the media parameters of the topper may be synchronized to one or more media parameters of the bidding creative to create the targeted creative for seamless and consecutive playing. In an embodiment, the stitched targeted creative now appears as a single creative and selected as the targeted creative for bidding on the ad request, as discussed above in S330, FIG. 3. It should be appreciated that synchronized stitching of the bidding creative and the topper creates a new media content, targeted creative, that consecutively and seamlessly plays when presented to a user via a user device (e.g., the user device 170, FIG. 1).

In an embodiment, the generation of targeted creatives may be simultaneously performed to generate a plurality of targeted creatives for the various bidding creatives that are received at the system (e.g., the system 140, FIG. 1). That is, targeted creatives with different bidding creatives and different toppers can be rapidly created at the same time. It should be noted that the generated targeted creatives are customized to increase accuracy of targeting user and/or devices in digital advertising. It should be further noted that such generation of a plurality of targeted creatives are performed near real-time to serve the targeted creatives within the rapid digital advertising system.

It should be noted that one or more versions of a targeted creative may be created for a specific bidding creative using the method described herein. Such different versions (including different toppers) of the targeted creative for the specific creative may be stored in a memory or a performance database (e.g., the performance database 150, FIG. 1). One of the different versions is selected based on the analysis of data features as described in S320, FIG. 3. In another embodiment, one of the different versions to replace the original bidding creative for bidding and serving is selected randomly.

FIG. 5 is an example flowchart S360 illustrating a method for performing multi-dimensional testing of versions of a targeted creative according to an embodiment. The method is illustrated for testing a version of the targeted creative to one test group, which may be repeated for one or more versions of the targeted creative and a plurality of test groups. In an embodiment, the testing method described herein may be performed as needed for targeted creatives regardless of the number of versions of the respective targeted creative. The method described herein may be executed by the system 140, FIG. 1.

At S510, a version of a targeted creative is designated to a test group. The version of the targeted creative is a single media content including the matched creative and the topper which are seamlessly stitched together. As noted above, each version of the targeted creative includes a creative that is common to the at least one version of the targeted creative, but includes a topper that is different from other versions of the at least one version of the targeted creative. In an embodiment, the test group includes one or more user devices (e.g., the user device 170, FIG. 1) and is consistent throughout a campaign of the creative. The test groups are selected randomly without specific criteria, where each test group includes similar number of user devices. In some embodiments, the test groups are selected based on, for example but not limited to, device ID, user ID, geographic location, associated CDN (e.g., the CDN 160, FIG. 1), and the like.

In an embodiment, the version is designated to the test group according to a plurality of selecting rules that are defined by, for example, but is not limited to, creatives and/or targeted creatives, toppers, category of creatives, and the like, and any combination thereof, that are served at the group. For example, the group is currently served with a targeted creative in the category of technology that include topper A. In such example, a version of an education category targeted creative also including topper A may not be designated to the same group. In another example, a version of targeted creative in the same technology category that include topper B may not be designated to the same group to prevent mixing of categories in the same test group.

At S520, the version of the targeted creative is caused to display to a viewer via a user device. In an embodiment, the version is displayed to a viewer upon determination as a winning bid for the ad request. In an embodiment, the version may be provided to the ad server (e.g., the ad server 110, FIG. 1) that determines the winning bid.

At S530, performance data for the displayed version are collected. The performance data includes, but not limited to, performance metrics and the survey metrics, which may be received as feedback data upon displaying the version of the targeted creative to the users of the user devices. The performance metrics may be received immediately upon projecting the targeted creatives from, for example but not limited to, the ad server and/or media streaming platform. In an example embodiment, the performance metrics include a video progress rate (VPR) score that indicates an extent of playback of the displayed targeted creative. The VPR score may be calculated as a sum of the first quartile rate, mid point rate, third quartile rate, and a completed rate, where each rate is distinctly weighted. As an example, a weight for the completed rate may be greater than a weight of the first quartile rate for calculating the VPR score of the displayed version of the targeted creative.

The survey metrics, for example but not limited to, memorability score, engagement score, entertainment score, and the like, may be obtained from a predetermined panel of viewers. The survey metrics indicate a degree of engagement and effectiveness of the projected targeted creatives that are difficult to obtain in media streaming advertising. In an embodiment, the survey metrics may be received as raw data and/or analyzed reports at a predefined time interval or after a predetermined duration of time. The survey metrics is stored together with the versions and the performance metrics in the performance database (e.g., the performance database 150, FIG. 1). In further embodiment, the survey feedback may be provided by third party companies.

At S540, a check is performed whether a score is greater than a threshold value. If so, execution continues with S545; otherwise, execution continues with S550. In an example embodiment, the threshold value is stored at the memory of the system 140, FIG. 1.

In an embodiment, the score is determined for the test group from the performance data received for the plurality of user devices in the group. In an embodiment, the score is determined based on the performance metric and/or the survey metric and rules defined by, for example, weights, scores, rankings, and the like of performance-related parameters, for example, but not limited to, completion rate, engagement score, and the like, and any combination thereof. In a further embodiment, the score may be generated for all user devices in the group. In an embodiment, the score is generated from performance data received within a predetermined duration of time and/or from a sufficient number of the targeted creative displayed via a user device. In an example embodiment, the score may be determined as a sum of the completion rate and at least one survey rate, each multiplied with a different predetermined weight. In a further example embodiment, the at least one survey rate is a global average survey rate determined from multiple surveys that were collected as feedback.

In an embodiment, the threshold value is a predetermined threshold value. In some embodiments, the threshold value may be determined from performance data received for a control group, which is a test group of a plurality of user devices that are designated to display the control version of the targeted creative (i.e., the original creative only without a topper).

At S545, optionally, a second version of the targeted creative is combined with the designated version (i.e., the first version) for the group. The second version is a different version of the targeted creative (i.e., version with same base creative and different topper) that obtained a score greater than a threshold value when the second version was tested in another, separate test group. In an example embodiment, more than one second version of the targeted creative may be combined.

In an embodiment, a version of the targeted creative with a score greater than the threshold value may be determined as an optimal version. In such a scenario, testing may end, and the optimal version may be continuously displayed for the testing group until a decision to stop (or perform optional combining of another version) is made. It should be understood that the optimal version is a version of the targeted creative deemed to perform effectively (favorably) to users of the user devices based on collected feedback performance data. For example, version 1, version 2, and version 3 are three different versions of a targeted creative including a creative of a restaurant and versions 1 and 2 are previously determined as optimal versions. In the same example, upon testing of version 3 to group 3, version 3 was also determined as an optional version. And thus, versions 1, 2, and 3, may be combined to be further tested in group 3.

At S550, the version of the targeted creative displaying the score equal or below the threshold value is disengaged from the group. The version of the targeted creative that was previously designated to the group is now eliminated based on the performance data. It should be noted that the disengaged version of the targeted creative is determined as being ineffective and may be stored as historical data in conjunction to the performance data and scores that were analyzed.

At S560, the test group is rested. The group that is disengaged of the version is given a rest period of, for example, five to ten days, in which no version of the targeted creative is displayed to the users of the test group. In an embodiment, the rest period is only applicable for the specific campaign (i.e., specific creative or group of related creatives) and testing may continue for other targeted creatives that utilize the same test group and/or user devices. It should be appreciated that the rest period allows resetting of the user devices (and respective users) in the test group with respect to the initially designated targeted creative in order to be utilized for further testing of new versions of the targeted creative. It should be further appreciated that efficient utilization of the groups reduces use of computer resources such as memory and processing power, which may otherwise be exhausted with large amount of test groups for the at least one versions of the targeted creative.

At S570, a new version is designated to the test group. In an embodiment, the new version may include a different version of the targeted creative that is, for example, not yet tested in the test group, not tested in any group, and the like. In another embodiment, the new version may include combination of versions of the targeted creative as determined in S545 in order to designate the same version (as designated in S510) and additional versions to the test group. The operation returns to S520 to perform multi-dimensional testing of the designated new version(s) of the targeted creative.

It should be noted that testing of different versions of the targeted creative is performed concurrently using separate target groups. Moreover, testing of different targeted creatives (i.e., different bidding creatives, different ad campaign) are simultaneously performed. It should be further appreciated that such simultaneous serving of various targeted creatives (as well as versions of each targeted creative) is performed within a sufficiently short time frame for bidding and serving in the digital advertising ecosystem. In an embodiment, the test groups and the user devices included within are substantially identical across the different targeted creatives for testing. In an example embodiment, steps of modifying the test groups (as illustrated in S540 to S570) may be suppressed during late hours of the day, for example and without limitation, between 12 am to 6 am in order to reduce anomalies that may arise at irregular hours. In a further example embodiment, portions of the performance data, for example only the performance metric, may be collected during such irregular hours.

In some embodiments, a test group may include one or more subgroups that are determined based on, for example, but not limited to, a geography, a content history, and the like, of the user device. A portion of the topper in the version of the targeted creative may be updated to include relevant information for the user devices in the subgroup. In an embodiment, the portions of the topper may include multimedia elements such as, but not limited to, images, texts, videos, and the like, in various layouts.

As an example, a version of the targeted creative for a pet store creative may include a topper introducing location and available products in the pet store. For the subgroup including user devices located in Orange County, California, the portion of the topper may be modified to display a QR code that leads to locations of the pet store in Orange County, California. In another example, the portion of the topper may be certain audio and/or image frames of the topper to show content-related images based on the common content history for the subgroup.

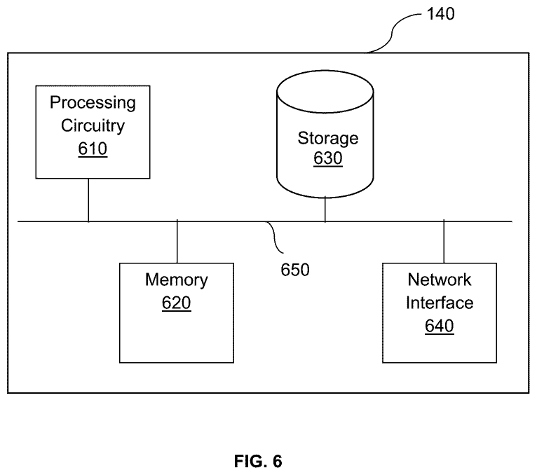

FIG. 6 is an example schematic diagram of a system 140 according to an embodiment. The system 140 includes a processing circuitry 610 coupled to a memory 620, a storage 630, and a network interface 640. In an embodiment, the components of the system 140 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose central processing units (CPUs), microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk—read only memory (CD-ROM), Digital Versatile Disks (DVDs), or any other medium which can be used to store the desired information.

The network interface 640 allows the classifier generator 130 to communicate with other elements over the network 170 for the purpose of, for example, receiving data, sending data, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), general purpose compute acceleration device such as graphics processing units (“GPU”), a memory, and input/output interfaces. The computer platform may also include an operating system and microinstruction code. The various processes and functions described herein may be either part of the microinstruction code or part of the application program, or any combination thereof, which may be executed by a CPU or a GPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining a targeted creative from multi-dimensional testing, comprising:
creating at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative;
designating a first version of the at least one version of the targeted creative to a group based on a plurality of selecting rules, wherein the group includes a plurality of user devices;
causing a display of the first version via the plurality of user devices of the group;
collecting performance data of the displayed first version from the group; and
determining the first version as an optimal version of the targeted creative based on the collected performance data.

2. The method of claim 1, wherein stitching the creative and the topper further comprises:
synchronizing media parameters of the topper to the at least one media parameter of the creative.

3. The method of claim 1, wherein the determining the first version as the optimal version further comprises:
comparing a score of the first version to a predetermined threshold value, wherein the score of the first version in the group is determined based on the collected performance data and rule; and
upon determination that the score is greater than the predetermined threshold value, identifying the first version as the optimal version of the targeted creative for the group.

4. The method of claim 1, further comprising:
determining the plurality of toppers for the creative based on a context of the creative, wherein the context is at least one category of the creative.

5. The method of claim 1, wherein the plurality of selecting rules is defined by a category of the creative and existing targeted creatives in the group.

6. The method of claim 1, wherein the performance data includes at least one of: a performance metric and a survey metric; and stored in a database with the displayed first version of the at least one version of the targeted creatives.

7. The method of claim 6, wherein the survey metric is received after a predefined time, and wherein the survey metric includes at least one of: a memorability score, an engagement score, an entertainment score, and a positivity score.

8. The method of claim 1, further comprising:
disengaging the first version of the at least one version of the targeted creative from the group;
preventing the display of the at least one version of targeted creative; and
designating a second version of the at least one version of the targeted creative to the group.

9. The method of claim 1, wherein the group is the first group and the optimal version is a first optimal version, further comprising:
combining the first optimal version and a second optimal version of the targeted creative, wherein the second optimal version is determined from a second group that includes user devices that are different from the first group; and
designating the first optimal version and the second optimal version to the first group for display via the plurality of user devices of the first group.

10. The method of claim 1, further comprising:
generating a subgroup within the group based on at least one of: geography and historical data, wherein the subgroup includes a subset of the plurality of user devices in the group;
determining a portion of the topper to be modified based on extracted data from an ad request, wherein the determined portion is part of the first version of the at least one version of the targeted creative; and
creating a sub-target version of the first version by modifying the portion of the topper, wherein the sub-target version replaces the first version and designated to the subgroup.

11. A non-transitory computer readable medium having stored thereon instructions for causing a processing circuitry to execute a process, the process comprising:
creating at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative;
designating a first version of the at least one version of the targeted creative to a group based on a plurality of selecting rules, wherein the group includes a plurality of user devices;
causing a display of the first version via the plurality of user devices of the group;
collecting performance data of the displayed first version from the group; and
determining the first version as an optimal version of the targeted creative based on the collected performance data.

12. A system for determining a targeted creative from multi-dimensional testing, comprising:
a processing circuitry; and
a memory, the memory containing instructions that, when executed by the processing circuitry, configure the system to:
create at least one version of a targeted creative, wherein each version of the at least one version includes a creative and a respective topper of a plurality of toppers, wherein the topper is a multimedia content element that is different for each version of the at least one version, wherein creating the at least one version further comprises stitching the creative and the topper based on at least one media parameter of the creative;
designate a first version of the at least one version of the targeted creative to a group based on a plurality of selecting rules, wherein the group includes a plurality of user devices;
cause a display of the first version via the plurality of user devices of the group;
collect performance data of the displayed first version from the group; and
determine the first version as an optimal version of the targeted creative based on the collected performance data.

13. The system of claim 12, wherein the system is further configured to:
synchronize media parameters of the topper to the at least one media parameter of the creative.

14. The system of claim 12, wherein the system is further configured to:
compare a score of the first version to a predetermined threshold value, wherein the score of the first version in the group is determined based on the collected performance data and rule; and
upon determination that the score is greater than the predetermined threshold value, identify the first version as the optimal version of the targeted creative for the group.

15. The system of claim 12, wherein the system is further configured to:
determine the plurality of toppers for the creative based on a context of the creative, wherein the context is at least one category of the creative.

16. The system of claim 12, wherein the plurality of selecting rules is defined by a category of the creative and existing targeted creatives in the group.

17. The system of claim 12, wherein the performance data includes at least one of: a performance metric and a survey metric; and stored in a database with the displayed first version of the at least one version of the targeted creatives.

18. The system of claim 17, wherein the survey metric is received after a predefined time, and wherein the survey metric includes at least one of: a memorability score, an engagement score, an entertainment score, and a positivity score.

19. The system of claim 12, wherein the system is further configured to:
disengage the first version of the at least one version of the targeted creative from the group;
prevent the display of the at least one version of targeted creative; and
designate a second version of the at least one version of the targeted creative to the group.

20. The system of claim 12, wherein the group is the first group and the optimal version is a first optimal version, the system is further configured to:
combine the first optimal version and a second optimal version of the targeted creative, wherein the second optimal version is determined from a second group that includes user devices that are different from the first group; and
designate the first optimal version and the second optimal version to the first group for display via the plurality of user devices of the first group.

21. The system of claim 12, wherein the system is further configured to:
generate a subgroup within the group based on at least one of: geography and historical data, wherein the subgroup includes a subset of the plurality of user devices in the group;
determine a portion of the topper to be modified based on extracted data from an ad request, wherein the determined portion is part of the first version of the at least one version of the targeted creative; and
create a sub-target version of the first version by modifying the portion of the topper, wherein the sub-target version replaces the first version and designated to the subgroup.
